(19) United States
(12) Patent Application Publication
(10) Pub. No.: US 2012/0215537 A1
(43) Pub. Date: Aug. 23, 2012

(54) Sound Recognition Operation Apparatus and Sound Recognition Operation Method

(76) Inventor: Yoshihiro Igarashi, Ome-shi (JP)

(21) Appl. No.: 13/238,883

(22) Filed: Sep. 21, 2011

(30) Foreign Application Priority Data
Feb. 17, 2011 (JP) 2011-032151

(51) Int. Cl. G10L 15/02

(52) U.S. Cl. 704/249; 704/E15.004

(57) ABSTRACT

According to one embodiment, a sound recognition operation apparatus includes a sound detection module, a keyword detection module, an audio mute module, and a transmission module. The sound detection module is configured to detect sound. The keyword detection module is configured to detect a particular keyword using voice recognition when the sound detection module detects sound. The audio mute module is configured to transmit an operation signal for muting audio sound when the keyword detection module detects the keyword. The transmission module is configured to recognize the voice command after the keyword is detected by the keyword detection module, and transmit an operation signal corresponding to the voice command.

### CROSS-REFERENCE TO RELATED APPLICATIONS

This application is based upon and claims the benefit of priority from prior Japanese Patent Application No. 2011-032151, filed Feb. 17, 2011, the entire contents of which are incorporated herein by reference.

### FIELD

Embodiments described herein relate generally to a sound recognition operation apparatus and a sound recognition operation method for recognizing a voice command and operating a controlled device.

### BACKGROUND

As is well known, in recent years, instead of a conventional remote control for remotely controlling a controlled device by sending an operation signal according to user's key operation, a remote control with a voice recognition function has been developed which recognizes a user's voice command, transmits an operation signal according to the voice command, and thereby remote-controls the controlled device.

It should be noted that the remote control with the above voice recognition function eliminates cumbersome work of selecting and operating a desired key from among many keys on the conventional remote control, but has a drawback in that the remote control may malfunction by recognizing ambient noise. Therefore, the remote control with the above voice recognition function still has a lot of issues left to be improved in various points before it is put into practical use.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram illustrating an example of a SOUND recognition remote control system according to an embodiment;

FIGS. 2A, 2B, and 2C are external views each for explaining an example of a remote control constituting the voice recognition remote control system according to the embodiment;

FIG. 3 is a block configuration diagram for explaining an example of a signal processing system of the remote control according to the embodiment;

FIG. 4 is a block configuration diagram for explaining an example of a signal processing system of a digital television broadcast receiver apparatus constituting the sound recognition remote control system according to the embodiment; and

FIG. 5 is a flowchart for explaining an example of major processing operations performed by the remote control according to the embodiment.

### DETAILED DESCRIPTION

Various embodiments will be described hereinafter with reference to the accompanying drawings. In general, according to one embodiment, a sound recognition operation apparatus comprises a sound detection module, a keyword detection module, an audio mute module, and a transmission module. The sound detection module is configured to detect sound. The keyword detection module is configured to detect a particular keyword using voice recognition when the sound detection module detects sound. The audio mute module is configured to transmit an operation signal for muting audio sound when the keyword detection module detects the keyword. The transmission module is configured to recognize the voice command after the keyword is detected by the keyword detection module, and transmit an operation signal corresponding to the voice command.

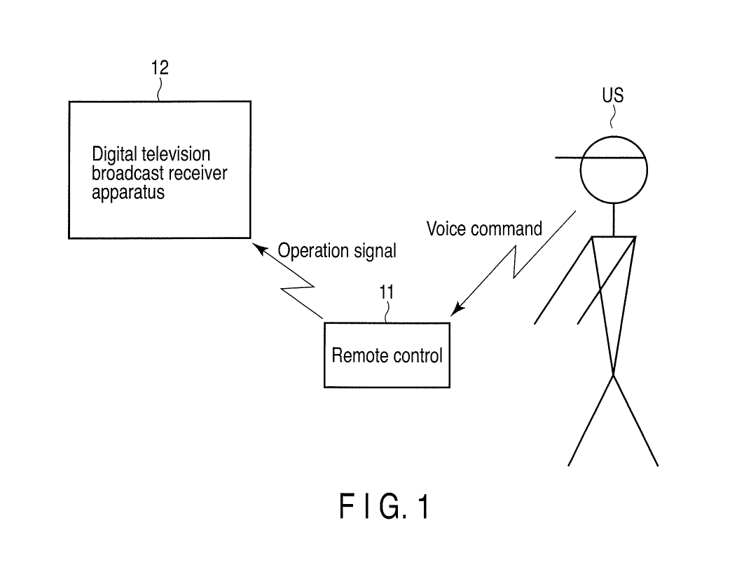

FIG. 1 illustrates the example of the sound recognition remote control system explained in the embodiment. The sound recognition remote control system is configured to allow a user US to use a remote control 11 having voice recognition function to control a digital television broadcast receiver apparatus 12 serving as a controlled device.

In other words, when the user US issues a voice command, the voice command is recognized by the remote control 11. Then, the remote control 11 generates an operation signal corresponding to the recognized voice command, and wirelessly transmits the operation signal to the digital television broadcast receiver apparatus 12 using, for example, infrared light or radio wave as a transmission medium.

Therefore, the digital television broadcast receiver apparatus 12 receives the operation signal transmitted by the remote control 11, and controls each module so that each module attains a state corresponding to the content of operation thereof. As a result, using the voice command of the user US, the digital television broadcast receiver apparatus 12 serving as the controlled device can be remote-controlled.

In this case, the remote control 11 is set to a handclap detection mode as a state prior to detection of voice command generated by the user US. In the handclap detection mode, the remote control 11 uses voice recognition to detect whether the user US successively claps hands a number of times defined in advance (for example, twice) or more.

Then, when a successive clapping sound of the predetermined number of claps defined in advance or more is detected in the state set in the handclap detection mode, the remote control 11 is set in a keyword detection mode. In the keyword detection mode, the remote control 11 performs voice recognition of only particular keywords defined in advance (for example, “television”), and uses voice recognition to detect a particular keyword said by the user US.

As described above, when a particular keyword is detected in a state set in the keyword detection mode, the remote control 11 transmits an operation signal to the digital television broadcast receiver apparatus 12 to set the audio in a muted state. Thereafter, the remote control 11 is set in a voice command recognition mode for recognizing various kinds of voice commands given by the user US to the digital television broadcast receiver apparatus 12.

Then, when the user US issues a voice command in the state set in the voice command recognition mode, the remote control 11 recognizes the voice command generated by the user US, generates an operation signal corresponding to the recognized voice command, and wirelessly transmits the operation signal to the digital television broadcast receiver apparatus 12. Accordingly, the digital television broadcast receiver apparatus 12 is wirelessly controlled by the user US's voice command.

In this manner, the voice command generated by the user US is recognized, the operation signal corresponding to the recognized voice command is generated, and the operation signal is wirelessly transmitted to the digital television broadcast receiver apparatus 12. Then, the remote control 11 is set in the handclap detection mode again to enter into a waiting state for detecting a subsequent clap by the user US.

In the above remote control 11, the voice command given by the user US to the digital television broadcast receiver apparatus 12 is recognized only after the user US successively claps hands the number of times defined in advance or more and subsequently says the particular keyword defined in advance. Therefore, the voice command given by the user US can be recognized as correctly as possible without being affected by ambient noise, and this allows the digital television broadcast receiver apparatus 12 to be correctly controlled as desired by the user US.

Further, the remote control 11 as described above detects a successive clapping sound of the predetermined number of clappings defined in advance or more, and subsequently, makes the audio of the digital television broadcast receiver apparatus 12 in the muted state while a particular keyword defined in advance is detected. Therefore, the voice command generated by the user US can be correctly recognized without being blocked by the audio generated by the digital television broadcast receiver apparatus 12.

When the audio of the digital television broadcast receiver apparatus 12 is set in the muted state, the audio may not necessarily be in a complete muted state, i.e., 100% muted state. For example, the volume may be reduced to half the current volume level as necessary. In other words, the audio may be set in 50% muted state. In other words, the audio mute includes meaning of reducing the volume to a level lower than the current volume level.

When the voice command generated by the user US is recognized, and the digital television broadcast receiver apparatus 12 is controlled to enter into a new state on the basis of the operation signal transmitted according to the voice command, the digital television broadcast receiver apparatus 12 automatically cancels the audio-muted state.

However, when the digital television broadcast receiver apparatus 12 does not have a function of automatically cancelling the audio-muted state, it is necessary for the remote control 11 to transmit an operation signal to the digital television broadcast receiver apparatus 12 to cause the digital television broadcast receiver apparatus 12 to cancel the audio-muted state.

In this case, the remote control 11 can operate in two ways. The first way of operation includes transmitting an operation signal for canceling audio-mute when a voice command given by the user US is recognized, transmitting an operation signal corresponding to the voice command, and entering into the handclap detection mode. The second way of operation includes transmitting an operation signal corresponding to a voice command when the voice command given by the user US is recognized, transmitting an operation signal for canceling audio-mute, and entering into the handclap detection mode.

It should be noted that the processing for transmitting the operation signal for canceling audio-mute and the processing for transmitting the operation signal corresponding to the voice command can be executed substantially at the same time, and these two processings may be executed at any point in time before or after entering into the handclap detection mode.

Further, even if the remote control 11 falsely recognizes, for example, a sound of a bouncing ball or of a knock at the door as a clapping sound in the handclap detection mode, the remote control 11 does not enter into the voice command recognition mode unless a particular keyword is thereafter detected in the keyword detection mode. Therefore, the remote control 11 can prevent erroneous operation to a minimum.

Since a particular keyword is detected on condition that a successive clapping sound of the predetermined number of claps defined in advance or more is detected, it is not necessary to use a peculiar phrase (for example, a word that is not used in everyday conversation) as a particular keyword. Even when the user US uses an easy word such as “television” which tends to be used in everyday conversation, erroneous operation prevention effect can be expected. Therefore, there is an advantage in that the user US can set a keyword that the user US can easily pronounce.

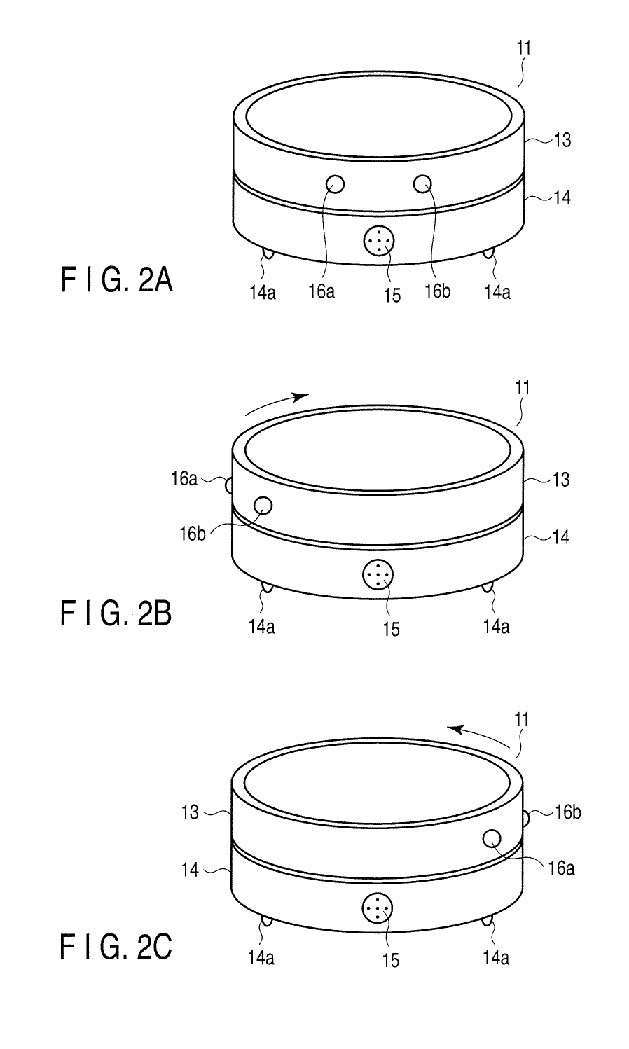

FIG. 2A illustrates an external view of the remote control 11. The remote control 11 is structured such that two bodies 13, 14, formed substantially in a thin cylindrical shape, are overlapped concentrically. In the remote control 11, a plurality of leg portions 14a (in the figure, only two leg portions are shown) are provided in a protruding manner from the bottom surface of one of the bodies, i.e., the body 14, so that, for example, the remote control 11 is placed on a horizontal base such as a table.

On the side surface of the body 14, a microphone 15 is provided. Further, a pair of infrared light emitting diodes (LED) 16a, 16b is provided on the side surface of the other of the bodies, i.e., the body 13. Then, the remote control 11 uses the microphone 15 to collect voice information such as clapping, keywords, and voice commands, and wirelessly transmits operation information from the pair of infrared LEDs 16a, 16b.

Further, the remote control 11 is configured such that the two bodies 13, 14 can rotate with respect to each other about the center of axis thereof. In other words, with respect to the body 14, the body 13 can be rotated in a right direction as shown in FIG. 2B, and the body 13 can be rotated in a left direction as shown in FIG. 2C.

Accordingly, the remote control 11 can be finely adjusted in accordance with each position, so that the microphone 15 faces a direction where the user US resides and the pair of infrared LEDs 16a, 16b faces a direction where the digital television broadcast receiver apparatus 12 resides.

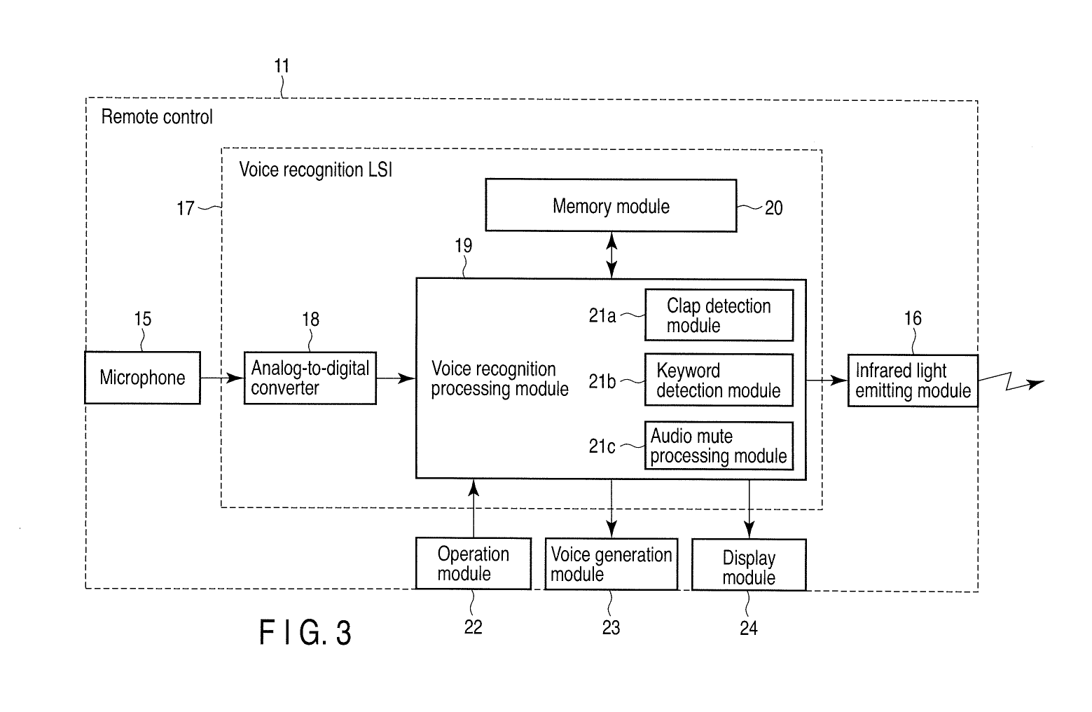

FIG. 3 illustrates an example of a signal processing system of the remote control 11. In other words, the sound information collected by the microphone 15 is provided as an audio signal to a voice recognition large-scale integration (LSI) IC 17. The voice recognition LSI 17 uses an analog-to-digital converter 18 to digitize the input audio signal, and provides the digitized signal to a voice recognition processing module 19.

The voice recognition processing module 19 performs voice recognition on the input digital audio signal. When the input audio signal is determined to be a voice command generated by the user US, the voice recognition processing module 19 outputs an operation signal corresponding to the voice command. Then, the operation signal output from the voice recognition processing module 19 is transmitted by an infrared light emitting module 16 constituted by the pair of infrared LEDs 16a, 16b using infrared light as a transmission medium, and the operation signal is received by the digital television broadcast receiver apparatus 12.

In this case, the voice recognition processing module 19 includes a memory module 20. In other words, the memory module 20 stores various kinds of voice commands given to the digital television broadcast receiver apparatus 12 and a voice command operation code correspondence table in which the voice commands are associated with encoded operation codes.

Then, the voice recognition processing module 19 performs voice recognition on the input digital audio signal. When the input audio signal is determined to be a voice command generated by the user US, the voice recognition processing module 19 searches the voice command operation code correspondence table for an operation code corresponding to the voice command, and outputs the found operation code to the infrared light emitting module 16 as an operation signal.

The voice recognition processing module 19 includes a clap detection module 21a, a keyword detection module 21b, and an audio mute processing module 21c. Among the above, the clap detection module 21a detects whether the user US successively claps hands the number of times defined in advance or more. In this case, the sound of a clap is recognized as an impulse. The clap detection module 21a may perform operation for detecting the number of times the impulse is generated, and therefore, this can be achieved with a circuit having a simple configuration consuming only a small amount of power.

Therefore, in the handclap detection mode before the voice command generated by the user US is recognized, the remote control 11 mainly supplies electric power to the analog-to-digital converter 18 and clap detection module 21a but does not supply any electric power to the voice recognition processing module 19 other than the clap detection module 21a, thus reducing the amount of power consumption.

In other words, in the handclap detection mode, mainly, the analog-to-digital converter 18 and clap detection module 21a are in a driven state, and the voice recognition processing module 19 other than the clap detection module 21a is in a non-driven (sleep) state. Therefore, when the remote control 11 is driven by electric power provided by a battery, the electric power of the battery can be saved.

Then, when the clap detection module 21a detects a successive clapping sound of the predetermined number of claps defined in advance or more, the electric power is supplied to the entire voice recognition processing module 19. In other words, the entire voice recognition processing module 19 enters into a driven state. Accordingly, the voice recognition processing module 19 can thereafter perform voice recognition of, e.g., particular keywords and voice commands generated by the user US.

The keyword detection module 21b performs voice recognition of only particular keywords defined in advance in the keyword detection mode explained above, thus using voice recognition to detect a particular keyword said by the user US.

Further, when a particular keyword is detected in the keyword detection mode, the audio mute processing module 21c transmits an operation signal to the digital television broadcast receiver apparatus 12 to set the audio in a muted state.

It should be noted that the clap detection module 21a and the keyword detection module 21b may be separately configured, or one voice detection module may be configured to include both of clap detection function and keyword detection function.

Further, the voice recognition processing module 19 is connected to an operation module 22. The operation module 22 includes a power switch and a plurality of manipulators with which the user US sets various settings and the like of the remote control 11. Then, on the basis of the operation signal obtained from the operation module 22, the voice recognition processing module 19 controls each module so that the content of operation is reflected.

Further, the voice recognition processing module 19 is connected to a voice generation module 23. Therefore, the voice recognition processing module 19 uses the voice generation module 23 to notify, by sound, the user US of operational state and setting state of the remote control 11 or input request and input confirmation for the user US.

The voice recognition processing module 19 is connected to a display module 24. Accordingly, the voice recognition processing module 19 uses the display module 24 to notify, using a method such as blinking light, the user US of operational state and setting state of the remote control 11 or input request and input confirmation for the user US.

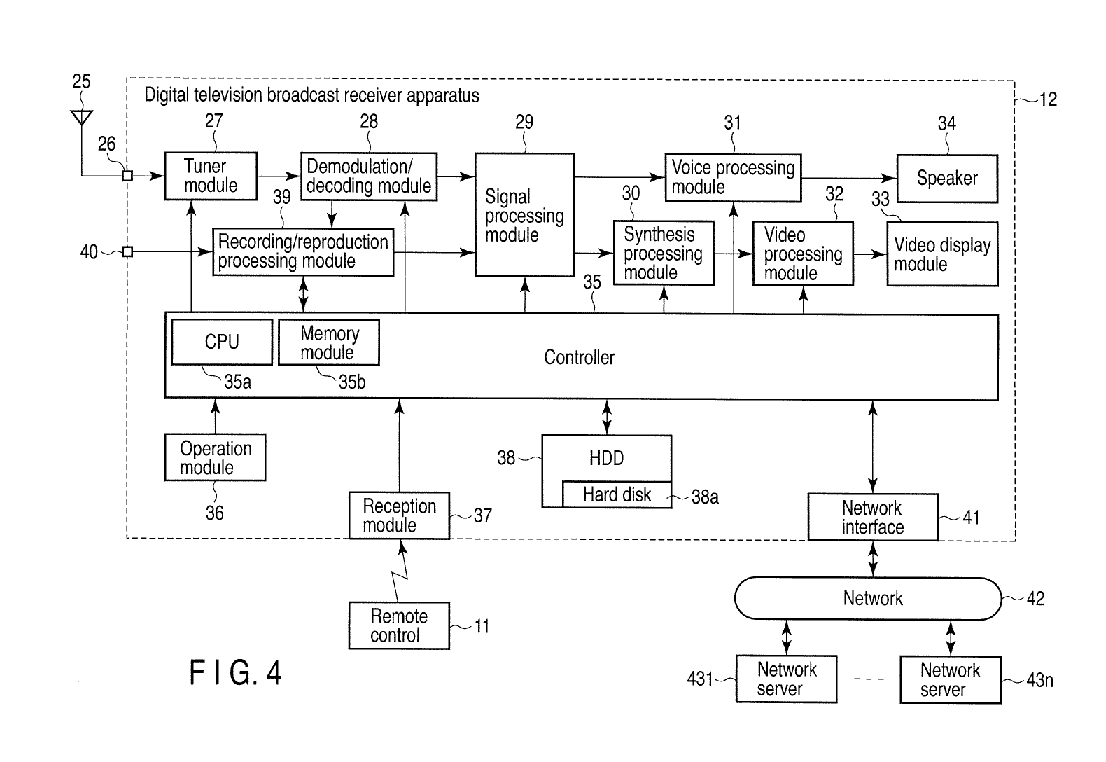

FIG. 4 schematically illustrates a signal processing system of the digital television broadcast receiver apparatus 12, i.e., the example of the controlled device. In other words, a digital television broadcast signal received by an antenna 25 is supplied to a tuner module 27 via an input terminal 26, so that the digital television broadcast receiver apparatus 12 tunes in on a broadcast signal of a desired channel.

The broadcast signal tuned in by the tuner module 27 is output to a signal processing module 29 after the broadcast signal is supplied to a demodulation/decoding module 28 to be demodulated into a digital video signal, a digital audio signal, and the like. The signal processing module 29 respectively performs predetermined digital signal processings on the digital video signal and the digital audio signal supplied by the demodulation/decoding module 28.

Then, the signal processing module 29 outputs the digital video signal to a synthesis processing module 30, and outputs the digital audio signal to a voice processing module 31. Among them, the synthesis processing module 30 overlays an on-screen display (OSD) signal onto the digital video signal supplied by the signal processing module 29, and outputs the digital video signal to a video processing module 32.

The video processing module 32 converts the input digital video signal into a format in which the video can be displayed on a flat video display module 33 including, for example, a liquid crystal display panel provided at a later stage. Then, the video signal output from the video processing module 32 is supplied to the video display module 33, which displays the video.

The voice processing module 31 converts the input digital audio signal into an analog audio signal in a format in which the voice can be reproduced by a speaker 34 at a later stage. Then, the analog audio signal output from the voice processing module 31 is supplied to the speaker 34, which reproduces the voice.

In this case, in the digital television broadcast receiver apparatus 12, a controller 35 centrally controls all the operations thereof including various kinds of reception operations described above. The controller 35 includes a central processing unit (CPU) 35a. The controller 35 receives an operation signal from an operation module 36 provided in the main body of the digital television broadcast receiver apparatus 12 or receives an operation signal transmitted by the remote control 11 and received by a reception module 37, thereby controlling each module so that the content of operation is reflected.

In this case, the controller 35 uses a memory module 35b. The memory module 35b mainly includes a read-only memory (ROM) for storing a control program executed by the CPU 35a, a random access memory (RAM) for providing a work area to the CPU 35a, and a nonvolatile memory for storing various kinds of setting information, control information, and the like.

The controller 35 is connected to an HDD (hard disk drive) 38. Based on operation of the operation module 36 and the remote control 11 by a user, the controller 35 controls a recording/reproduction processing module 39 so that the digital video signal and the digital audio signal obtained from the demodulation/decoding module 28 are encrypted and converted into a predetermined recording format by the recording/reproduction processing module 39. Thereafter, the converted signals are supplied to the HDD 38, so that a hard disk 38a records the signals.

In addition, based on operation of the operation module 36 and the remote control 11 by a user, the controller 35 controls the HDD 38 so that the digital video signal and the digital audio signal are read from the hard disk 38a, and are decoded by the recording/reproduction processing module 39. Thereafter, the signals are supplied to the signal processing module 29, so that the signals are displayed as a video and reproduced as a sound as described above.

The digital television broadcast receiver apparatus 12 is connected to an input terminal 40. The input terminal 40 is used to directly receive the digital video signal and the digital audio signal from the outside of the digital television broadcast receiver apparatus 12. Based on the control performed by the controller 35 in accordance with operation of the operation module 36 and the remote control 11 by a user, the digital video signal and the digital audio signal received via the input terminal 40 are supplied to the signal processing module 29 via the recording/reproduction processing module 39, and thereafter the signals are displayed as a video and reproduced as a sound as described above.

Based on the control performed by the controller 35 in accordance with operation of the operation module 36 and the remote control 11 by a user, the digital video signal and the digital audio signal received via the input terminal 40 pass through the recording/reproduction processing module 39, and are thereafter supplied to the HDD 38 so that the hard disk 38a records and reproduces the signals.

Further, the controller 35 is connected to an external network 42 via a network interface 41. Therefore, based on operation of the operation module 36 and the remote control 11 by a user, the controller 35 can selectively access a plurality of network servers 431 to 43n on the network 42, thereby using various kinds of services provided there.

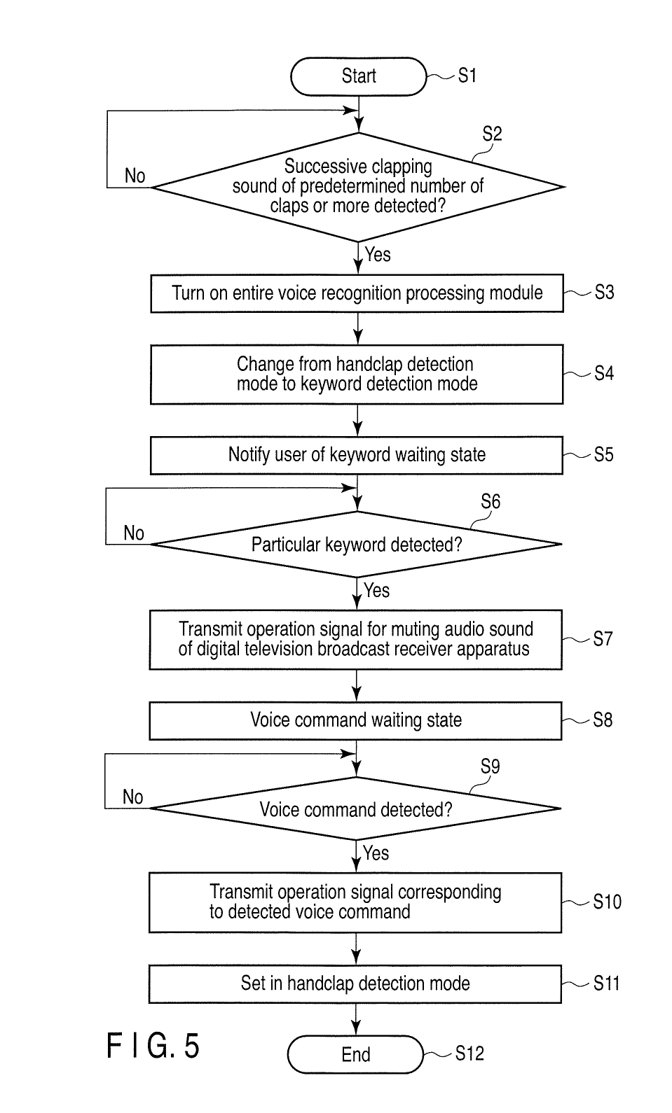

FIG. 5 is a flowchart illustrating a summary of an example of major processing operations performed by the remote control 11. This processing operation is started (step S1) in a setting where the remote control 11 is in the handclap detection mode, i.e., mainly the analog-to-digital converter 18 and clap detection module 21a are in the driven state, and the voice recognition processing module 19 other than the clap detection module 21a is in the non-driven (sleep) state.

Then, in step S2, the remote control 11 determines whether a successive clapping sound of the predetermined number or more of claps defined by the clap detection module 21a in advance is detected or not. When the successive clapping sound is determined to be detected (YES), the electric power is supplied to the entire voice recognition processing module 19 in step S3, so that the entire voice recognition processing module 19 enters into the driven state.

Thereafter, in step S4, the remote control 11 is switched from the handclap detection mode to the keyword detection mode in which voice recognition is performed on only particular keywords. In step S5, the remote control 11 notifies the user US that the remote control 11 is in a so-called keyword waiting state in which the remote control 11 waits for input of a particular keyword.

Examples of means for notifying the user US of the keyword waiting state include a method for generating an alarm sound such as repeated beeps using the voice generation module 23 and a method for generating a voice message such as “waiting for keyword” using the voice generation module 23. In addition, examples of means further include a method for blinking a light using the display module 24 and a method for displaying a text message such as “waiting for keyword” on the display module 24.

Further, a method for causing the remote control 11 to transmit an operation signal to cause the digital television broadcast receiver apparatus 12 to generate an alarm sound or voice message from the speaker 34 thereof may also be considered as an example of means for notifying the user US of the keyword waiting state. In addition, a method for causing the remote control 11 to transmit an operation signal to the digital television broadcast receiver apparatus 12 to display a text message on the video display module 33 may also be considered.

As described above, the remote control 11 may use the voice generation module 23, the display module 24, and the like provided on the remote control 11 to notify the keyword waiting state, or alternatively, the remote control 11 may use the video display module 33, the speaker 34, and the like of the controlled device (in this case, the digital television broadcast receiver apparatus 12) to notify the keyword waiting state.

Then, in step S6, the remote control 11 determines whether a particular keyword is detected or not. When the particular keyword is determined to be detected (YES), the remote control 11 transmits an operation signal to the digital television broadcast receiver apparatus 12 to set the audio in the muted state in step S7, and enters into a waiting state for waiting input of a voice command in step S8.

Thereafter, the remote control 11 determines whether a voice command is detected or not in step S9. When the voice command is determined to be detected (YES), the remote control 11 transmits an operation signal corresponding to the detected voice command in step S10, sets the handclap detection mode, i.e., mainly the analog-to-digital converter 18 and clap detection module 21a are in the driven state, and the voice recognition processing module 19 other than the clap detection module 21a is in the non-driven (sleep) state in step S11, and terminates the processing (step S12).

It should be noted that the remote control 11 automatically returns to the handclap detection mode when a particular keyword is not detected within a predetermined time defined in advance since a successive clapping sound of the predetermined number of claps defined in advance or more is detected or when a voice command given by the user US is not detected within a predetermined time defined in advance since a particular keyword is detected. Accordingly, useless power consumption can be suppressed.

Subsequently, a mode of use for operating the digital television broadcast receiver apparatus 12 using the above remote control 11 will be explained. In other words, users US are known to often surf channels, i.e., to watch programs while frequently changing available channels when the users US watch digital television broadcast programs on the digital television broadcast receiver apparatus 12.

Then, to surf with the remote control 11, the user US issues a voice command, for example, “surf up”. Then, the remote control 11 automatically transmits operation signals for sequentially selecting from a plurality of available channels every few seconds, so as to select channels from a channel of the lowest channel number to a channel of the highest channel number. In this case, the user US can successively watch broadcast programs in the plurality of available channels while sequentially changing the channel every few seconds from a channel of the lowest channel number to a channel of the highest channel number.

Alternatively, when the user US issues the voice command, for example, “surf up”, the remote control 11 can automatically transmit operation signals for sequentially selecting from a plurality of available channels every few seconds, so as select the channels from the currently selected channel to a channel of the highest channel number. In this case, the user US can successively watch broadcast programs in the plurality of available channels while sequentially changing the channel every few seconds from the currently selected channel to a channel of the highest channel number.

Conversely, when the user US issues a voice command, for example, “surf down”, the remote control 11 automatically transmits operation signals for sequentially selecting from a plurality of available channels every few seconds, so as to select from the channels from a channel of the highest channel number to a channel of the lowest channel number. In this case, the user US can successively watch broadcast programs in the plurality of available channels while sequentially changing the channel every few seconds from a channel of the highest channel number to a channel of the lowest channel number.

Alternatively, when the user US issues the voice command, for example, “surf down”, the remote control 11 can automatically transmit operation signals for sequentially selecting from a plurality of available channels every few seconds, so as to select from the channels from the currently selected channel to a channel of the lowest channel number. In this case, the user US can successively watch broadcast programs in the plurality of available channels while sequentially changing the channel every few seconds from the currently selected channel to a channel of the lowest channel number.

When the user US issues a voice command such as “stop” or “this channel” while the channel is automatically changed every few seconds in this manner, the remote control 11 stops the automatic channel change processing as soon as the voice command is received. As a result, the user US can continuously watch a broadcast program in the channel specified by the voice command.

Alternatively, when the user US issues a voice command “next” while the channel is automatically changed every few seconds, the remote control 11 immediately transmits an operation command for changing to a subsequent channel without waiting for a broadcast channel of a currently displayed program for several seconds.

Alternatively, when the user US issues a voice command such as “more” or “extend” while the channel is automatically changed every few seconds, the remote control 11 does not change the broadcast channel of the currently displayed program within several seconds, and waits for several more seconds and then transmits an operation signal for changing to a subsequent channel.

When the user US successively issues voice commands such as “next, next, next” while the channel is automatically changed every few seconds, the remote control 11 immediately transmits an operation signal for changing the channel to a subsequent channel as many as the number of times the user US issues “next” as the voice command. As a result, it is possible to skip as many channels as the number of times the user US has said “next”.

When the user US issues a voice command “faster” while the channel is automatically changed every few seconds, the remote control 11 transmits operation commands for changing to a subsequent channel with an interval shorter (for example, half the ordinary interval) than the ordinary internal (several seconds), so that the interval for changing the channel can be reduced.

Conversely, when the user US issues a voice command “slower” while the channel is automatically changed every few seconds, the remote control 11 transmits operation commands for changing to a subsequent channel with an interval longer (for example, double the ordinary interval) than the ordinary internal (several seconds), so that the interval for changing the channel can be increased.

In this case, when the processing for automatically changing the channel every few seconds is started in response to the voice command given by the user US, the remote control 11 uses the operation signal to notify the digital television broadcast receiver apparatus 12 that surfing is about to begin. With this notification, a message “surfing” can be displayed on the screen of the digital television broadcast receiver apparatus 12, or an indicator (such as an LED), not shown, of the digital television broadcast receiver apparatus 12 can be turned on or blinked. Accordingly, the user US can visually understand that the remote control 11 is currently carrying out automatic surfing processing.

It should be noted that the message “surfing” may not be displayed on the screen or the indicator of the digital television broadcast receiver apparatus 12. Alternatively, for example, a method for blinking light using the display module 24 of the remote control 11 and a method for displaying a text message such as “surfing” on the display module 24 may be employed.

In addition, time information is notified to the digital television broadcast receiver apparatus 12 using the operation signal every time one second passes since the remote control 11 changes the channel while the channel is automatically changed every few seconds. With this time information, a count-down indication in seconds, which shows a remaining second before the channel is automatically changed to a subsequent channel, can be displayed on the screen of the digital television broadcast receiver apparatus 12.

It should be noted that the count-down indication showing a remaining time before the channel is automatically changed to a subsequent channel may not be displayed on the screen of the digital television broadcast receiver apparatus 12. Alternatively, it may be notified to the user US by an alarm sound emitted from the speaker 34. Still alternatively, it may be notified to the user US by an alarm sound generated by the voice generation module 23 of the remote control 11.

In this case, when the channel is automatically changed every few seconds in the surfing process, all the available channels may be surfed. In this case, when the user US issues a voice command “surf up” or “surf down”, the remote control 11 automatically transmits operation signals for sequentially selecting from all the available channels every few seconds, so that the user US can sequentially watch each one of broadcast programs in all the available channels.

It should be noted that, in some cases, the number of available channels may be more than 100. In this case, it is considered impractical to surf all the available channels. Accordingly, the user US may register favorite channels to the digital television broadcast receiver apparatus 12 in advance, so that only the registered channels are included in the channels changed in the surfing process.

In this case, the user US issues a voice command such as “favorite channels up” or “favorite channels down”. Then, the remote control 11 automatically transmits operation signals for sequentially instructing favorite-channel-up or favorite-channel-down every few seconds. Then, every time the digital television broadcast receiver apparatus 12 receives operation signals for instructing favorite-channel-up or favorite-channel-down, the digital television broadcast receiver apparatus 12 changes the channel up or down to one of only the channels registered in the digital television broadcast receiver apparatus 12. In this case, the user US can sequentially watch each one of only the broadcast programs in the channels registered by the user US himself/herself.

Alternatively, the user US may register channel numbers of favorite channels to the remote control 11 in advance, so that only the registered channels are included in the channels changed in the surfing process. In this case, when the user US issues a voice command such as “favorite channels up” or “favorite channels down”, the remote control 11 transmits channels numbers of favorite channels registered therein (for example “1”, then “5”, and then “8”). Then, several seconds later, the remote control 11 transmits subsequent channel numbers of favorite channels registered therein (for example “3”, then “6”, and then “4”). In this case, the user US can sequentially watch each one of only the broadcast programs in the channels registered by the user US himself/herself.

Further, it may be possible to allow the user US to set the number of channels to be changed in the surfing process. In this case, for example, when the user US issues a voice command “surf up”, the remote control 11 automatically transmits operation signals for sequentially selecting from a plurality of available channels every few seconds, so as to select the channels from a channel of the lowest channel number to a channel of the highest channel number, but as soon as the remote control 11 changes as many channels as the number of channels set in advance, the remote control 11 automatically stops the surfing process.

In the embodiments described hereinabove, the digital television broadcast receiver apparatus 12 is used as an example of the controlled device. However, the controlled device is not limited to the digital television broadcast receiver apparatus 12. For example, this can be widely applied to a set top box (STB), an audio visual (AV) apparatus with voice playback function, and the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound recognition operation apparatus comprising:
a sound detection module configured to detect sound;
a keyword detection module configured to detect a particular keyword using voice recognition when the sound detection module detects the sound;
an audio mute module configured to transmit an operation signal for muting audio sound when the keyword detection module detects the keyword; and
a transmission module configured to recognize a voice command after the keyword detection module detects the keyword, and to transmit an operation signal corresponding to the voice command.

2. The sound recognition operation apparatus of claim 1, further comprising a notification controller configured to perform control so that when the sound detection module detects the sound, the notification controller notifies that the voice recognition operation apparatus is waiting for a keyword.

3. The sound recognition operation apparatus of claim 2, wherein the notification controller uses at least one of voice and display to perform control so as to notify that the voice recognition operation apparatus is waiting for a keyword.

4. The sound recognition operation apparatus of claim 1, wherein the keyword detection module is configured to detect a keyword by voice recognition only in a predetermined period of time since the sound detection module detects the sound.

5. The sound recognition operation apparatus of claim 1, wherein the transmission module is configured to recognize a voice command only in a predetermined period of time since the keyword detection module detects the keyword.

6. The sound recognition operation apparatus of claim 1, wherein the sound detection module is configured to detect a clapping sound.

7. The sound recognition operation apparatus of claim 6, wherein the sound detection module is configured to detect a successive clapping sound of a predetermined number of claps or more.

8. The sound recognition operation apparatus of claim 1, wherein the transmission module is configured to transmit an operation signal for automatically changing a channel with a predetermined interval of time when the voice command recognized by the voice recognition is determined to be a request for starting surfing.

9. The sound recognition operation apparatus of claim 1, wherein the transmission module is configured to stop transmission of the operation signal for changing the channel, and continuously tune in on the channel currently selected at that moment when the voice command recognized by the voice recognition is determined to be a request for stopping surfing.

10. The sound recognition operation apparatus of claim 8, wherein the transmission module is configured to change the interval with which the operation signal for changing the channel is transmitted when the voice command recognized by the voice recognition during the surfing is determined to be a request for changing an interval for changing the channel.

11. The sound recognition operation apparatus of claim 8, further comprising a notification module configured to notify that surfing is being performed.

12. A sound recognition operation method comprising:
causing a sound detection module to detect sound;
causing a keyword detection module to detect a particular keyword using voice recognition when the sound detection module detects the sound;
causing an audio mute module to transmit an operation signal for muting audio sound when the keyword detection module detects the keyword; and
recognizing a voice command after the keyword detection module detects the keyword, and causing a transmission module to transmit an operation signal corresponding to the voice command.
